(19) United States
(12) Patent Application Publication
(10) Pub. No.: US 2015/0226509 A1
(43) Pub. Date: Aug. 13, 2015

(54) SYSTEM AND METHOD FOR SIMULATED FIREARMS TRAINING

(71) Applicant: Shawn Hadler, New Palestine, IN (US)

(72) Inventor: Shawn Hadler, New Palestine, IN (US)

(21) Appl. No.: 14/619,046

(22) Filed: Feb. 10, 2015

Related U.S. Application Data
(60) Provisional application No. 61/937,760, filed on Feb. 10, 2014.

(51) Int. Cl. F41A 33/06; G09B 9/00

(52) U.S. Cl. CPC F41A 33/06; G09B 9/003

(57) ABSTRACT

A simulated firearm comprises an integrated camera that is disposed within the firearm where the barrel of a standard firearm would normally be. The camera is used to capture video and still images of one or more training exercises, with simulated “hits” being superimposed on a video stream or still photographic image of the training exercise, as captured by camera. This allows the trainee to replay the video stream and/or view and analyze the placement of the “hits” on the target, thereby enhancing the overall training paradigm. Also disclosed is a method of using a simulated firearm where certain video or still images of the training scenario are captured for later review and analysis. The video and still images can be captured automatically based on the activation of the trigger mechanism on the simulated firearm or in a manual fashion by the trainee or an instructor providing the training scenario.

### BACKGROUND OF THE INVENTION

1. Technical Field

The present invention relates to the field of firearms and more specifically relates to the use of simulated firearms for firearms training purposes.

2. Background Art

Firearms training is generally considered to an essential part of any occupation where firearms are normally used by the persons involved in the occupation. This includes, for example, military forces, police forces, security personnel, etc. However, firearms training can be expensive and dangerous, especially when live ammunition is used. Prior attempts to make firearms training safer through use of simulated ammunition have proven to be less than optimal for some purposes and wholly inadequate in other situations. In addition, the use of live ammunition and simulated ammunition typically fails to provide sufficient data for feedback to the trainees, thereby limiting the effectiveness of the training process. Further, while the use of live ammunition in a controlled shooting range setting is a possible solution, a shooting range setting fails to effectively simulate all of the situations that may face law enforcement personnel or military personnel in the line of duty and normal course of activity.

Accordingly it is desired to provide a more practical and effective device for use in simulated firearms training Such a device will overcome the safety concerns arising from the use of live ammunition and simulated ammunition while providing for more effective training in less time.

### BRIEF SUMMARY OF THE INVENTION

A system and method for using simulated firearms in a training environment is disclosed. A simulated firearm comprises an integrated camera that is disposed within the firearm where the barrel of a standard firearm would normally be. The camera is used to capture video and/or still images of one or more training exercises, with simulated “hits” fired by the trainee being superimposed on a video stream or still photographic image of the training exercise, as captured by the integrated camera. For purposes of this disclosure, a simulated “hit” is a simulated bullet impact location that is calculated and then superimposed on one or more digital images captured by a digital camera.

This allows the trainee and the instructor or trainer to replay the video stream and/or view after completion of the training exercise and analyze the placement of the “hits” on the target, thereby enhancing the overall training paradigm. Also disclosed is a method of using a simulated firearm where certain video or still images of the training scenario are captured for later review and analysis. The video and still images can be captured automatically based on the activation of the trigger mechanism on the simulated firearm or in a manual fashion by the trainee or an instructor providing the training scenario.

### BRIEF DESCRIPTION OF THE FIGURES

The preferred embodiments of the present invention will hereinafter be described in conjunction with the appended drawings, wherein like designations denote like elements, and:

FIG. 1 depicts a simulated firearm in accordance with a preferred exemplary embodiment of the present invention;

FIG. 2 is a schematic representation of a series of images of a target marked by a system using a simulated firearm in accordance with a preferred exemplary embodiment of the present invention; and

FIG. 3 is a flowchart for a training method using a simulated firearm and associated target in accordance with a preferred exemplary embodiment of the present invention.

### DETAILED DESCRIPTION OF THE INVENTION

A system and method for using simulated firearms in a training environment is disclosed. A simulated firearm comprises an integrated camera that is disposed within the firearm where the barrel of a standard firearm would normally be. The camera is used to capture video and/or still images of one or more training exercises, with simulated “hits” fired by the trainee being superimposed on a video stream or still photographic image of the training exercise, as captured by the integrated camera.

This allows the trainee and the instructor or trainer to replay the video stream and/or view after completion of the training exercise and analyze the placement of the “hits” on the target, thereby enhancing the overall training paradigm. Also disclosed is a method of using a simulated firearm where certain video or still images of the training scenario are captured for later review and analysis. The video and still images can be captured automatically based on the activation of the trigger mechanism on the simulated firearm or in a manual fashion by the trainee or an instructor providing the training scenario.

Although cameras have been provided for use in conjunction with actual firearms in the past, the placement and location of the camera is typically sub-optimal. For example, if a camera is provided alongside the barrel of the firearm, the exact shot placement can be difficult to calculate and ascertain.

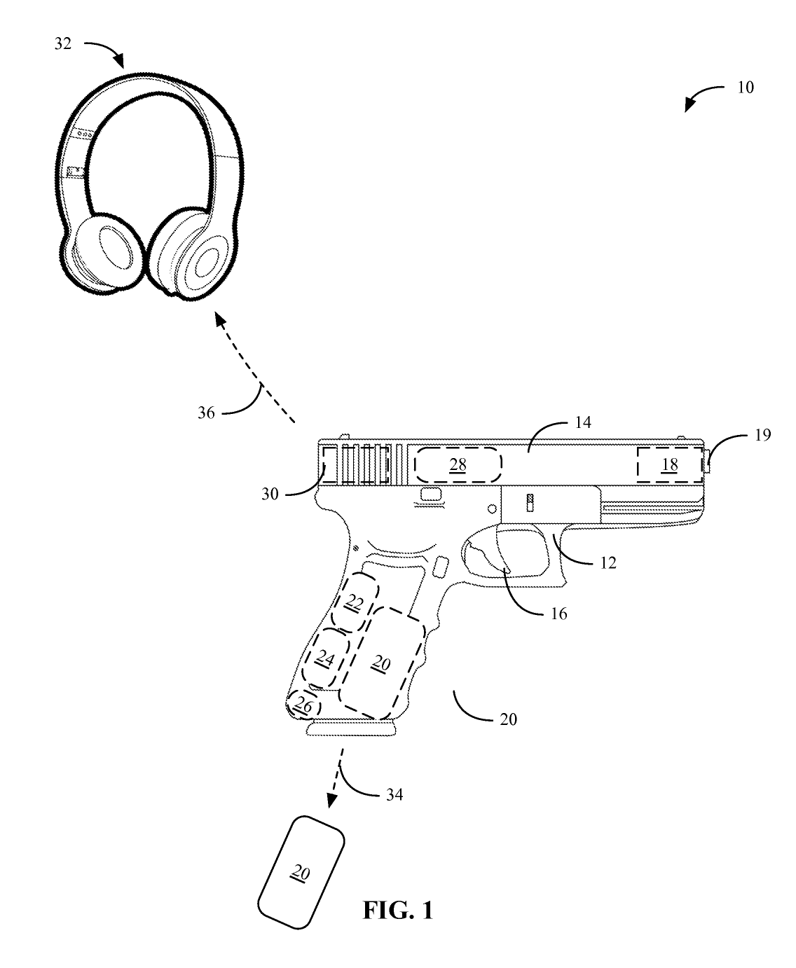

Referring now to FIG. 1, a simulated firearm 10 in accordance with a preferred exemplary embodiment of the present invention is depicted. As shown in FIG. 1, simulated firearm 10 comprises: a housing 12; a compression slide 14; and a trigger 16. Also shown in FIG. 1 is a digital camera 18, a battery 20, a processor 22, a memory 24, an interface 26, a solenoid 28, a counterweight 30, and a headset 32.

As shown in FIG. 1, housing 12 comprises an outer frame having substantially the same size and shape as a firearm model that simulated firearm 10 is replicating. In at least one preferred embodiment of the present invention, Housing 12 comprises substantially the same material from which the fire arm model replicated by simulated firearm 10 is constructed. Slide 14 comprises a slide mechanism designed to imitate the slight mechanism of the firearm model that simulated firearm 10 is replicating. Trigger 16 functions in the same fashion as a trigger of a firearm model but simulated firearm 10 is designed to replicate.

Digital camera 18 as shown in the embodiment of simulated firearm 10 of FIG. 1, Comprises a digital camera of the size and shape to fit within the nose of frame 12. For example, Digital camera 18 may comprise a high resolution digital camera capable of taking video and/or still photographs. Lens 19 of digital camera 18 is located where the muzzle of the firearm model that simulated firearm 10 is replicating normally would be. In certain preferred embodiments of the present invention, digital camera 18 will be ruggedized to reduce the chance of damage during normal use. Digital camera 18 is electronically connected with processor 22 and memory 24.

Battery 20 is a battery or other source of stored electrical energy. Battery 20 is utilized to provide electrical power to simulated firearm 10 as described herein. Battery 20 maybe any suitable battery that may occur to one of ordinary skill in the art after you have the present disclosure. For example, battery 20 may be any of a lithium ion battery, a nickel metal hydride battery, a nickel cadmium lead acid battery, or any other suitable battery technologies. In at least one preferred embodiment of the present invention battery 20 comprises a battery and capacitor arrangement suitable to supply and provide electrical power to simulated firearm 10 as described herein. In at least one preferred embodiment of the present invention battery 20 is removable from housing 12 in the direction shown by arrow 34.

Processor 22 comprises a device for processing computer instructions and is used to control the operation of simulated firearm 10. Processor 20 to software instructions a hardwired state machine, or a combination of these. Processor 20 maybe comprised of one or more components. For a multi component form of processor 20 to one or more components maybe located remotely relative to the other components or configured as a single unit. Furthermore processor 22 can be embodied in any form having more than one processing unit such as a multi-processor configuration and should be understood to collectively referred to such configurations as well as a single processor based arrangement. One or more components of processor 22 maybe of electronic variety defining digital circuitry analog circuitry or both. Processor 22 is electronically interconnected with digital camera 18 and memory 24.

Memory 24 comprises a medium suitable for electronic data storage. For example, memory 24 may be suitably represented by random access memory, a non-volatile hard drive storage, a non-volatile flash memory, volatile flash memory, removable magnetic media storage, optical storage, magnetic tape storage media, EPROM, and any combinations thereof. Memory 24 is electronically interconnected with digital camera 18 and processor 22. In at least one preferred embodiment of the present invention, memory 24 is removable from housing 12 and comprises a rechargeable battery pack.

Interface 26 is a hardware component that comprises a physical access port through which processor 22 and a memory 24 can be communicatively coupled to external devices. For example, data in memory 24 can be accessed by, manipulated by, an external device via a connection to interface 26. Similarly software firmware and data can be uploaded to processor 22 and/or memory 24 from an external device to interface 26. And at least one preferred embodiment of the present invention, interface 26 may comprise a male USB type A connector, a male USB type B connector, a male mini USB connector, a female mini USB connector, a male 4-pin IEEE 1394 connector, a female 4-pin IEEE 1394 connector, as well as any combinations thereof. In at least one preferred embodiment of the present invention, interface 26 comprises an antenna adapted for wireless communication between external devices and processor 22 and/or memory 24. This may include, for example, a Wi-Fi network, Bluetooth or other similar communication protocol known to those skilled in the art.

In at least one preferred embodiment of the present invention, solenoid 28 comprises a coil of wire wrapped around a cylindrical ferromagnetic core, based on the interaction of the coil with one or more induced magnetic fields. The cylindrical ferromagnetic material is movable with in the coil of wire. Further, in at least one preferred embodiment of the present invention, when an electric current is applied to the coil of wire the resulting magnetic field urges the ferromagnetic core from a first position to a second position.

In the most preferred embodiments of the present invention, counterweight 30 is connected to slide 14. In at least one preferred embodiment of the present invention, counterweight 30 comprises a mass selected and placed or positioned within the body or frame of simulated firearm 10 so as to provide simulated firearm 10 was substantially the same weight and center of gravity as the actual firearm that simulated firearm 10 is replicating. In other preferred embodiments of the present invention, simulated firearm 10 may comprise internal weighting that is selected and placed so as to provide simulated firearm 10 was substantially the same weight and center of gravity as the actual firearm that simulated firearm 10 is replicating.

Optional headset 32 comprises a device with one or more earpieces that communicatively coupled to simulated firearm 10 via a wired connection or a wireless connection established by any communication method known to those skilled in the art. For example, a radio frequency connection using Bluetooth or another similar radio communication protocol may be employed. Headset 32 may comprise an earmuff style headset, earbuds or another style of earpiece.

In operation, once trigger 16 is activated in a traditional way, digital camera 18 captures one or more images of the view through lens 19 at the time that trigger 16 was activated. If digital camera 18 is in “video mode,” an electronic “hit” or mark is overlaid or superimposed onto the video sequence captured at the precise time trigger 16 was activated so as to record the location of the target “hit” (in simulation) by simulated firearm 10 relative to the rest of the image captured by digital camera 18. Similarly, if digital camera 18 is in “still photograph” mode, then one or more still photographs will be captured by digital camera 18. These still photographs will also be marked with a “hit” being superimposed on the photographic image recorded by camera 18 at the precise time trigger 16 is activated. The video and/or still image captured by digital camera 18 is processed by processor 22 and then stored in memory 24. If so desired the video images and/or still images stored in memory 24 maybe downloaded to an external device via interface 26. Battery 20 provides electrical power to digital camera 18, processor 22, memory 24, and solenoid 28.

The location of the “hit” can be determined by any method known to those skilled in the art. For example, in at least one preferred embodiment of the present invention, the “hit” is simply superimposed at the exact center of the digital image because digital camera 18 is calibrated so that the digital images are exactly centered in the visual field of view for digital camera 18. Other options include laser tracking, geometric triangulation, 3-space positioning algorithms, etc.

When trigger 16 is activated by the trainee, a pulse of electric current is also released from battery 22 and applied to the magnetic coil contained within the interior space of solenoid 28. The coil thereby induces movement of the magnetic core in the direction of counter weight 30. The sudden, forceful movement of the core contained within solenoid 28 urges slide 14 to move towards the rear of frame 12, thereby simulating the action of slide 14 in a traditional handgun. The additional mass of counterweight 30 attached to slide 14 enhances the force of slide 14, thereby simulating the recoil exerted by a firearm when fired.

Additionally, in at least some preferred embodiments of the present invention, when trigger 16 is activated, a signal 36 is transmitted to headset 32, causing the pre-programmed sound of a gunshot to be emitted from headset 32. In this fashion, a trainee can both feel the recoil of the “shot” and hear the “report” from the “shot,” thereby enhancing the reality of the training environment and reinforcing the experience of actually firing the actual firearm being simulated by simulated firearm 10.

Additionally, in at least some preferred embodiments of the present invention, an instructor can send a signal to simulated firearm 10 and trigger digital camera 18 so as to capture digital images at a point in the training exercise other than when the trainee activates trigger 16.

According to at least one preferred embodiment of the present invention, Simulated firearm 10 is outfitted with a reset switch to require the user to periodically simulate the reloading of simulated firearm 10 in the same fashion and manner that a user would have to reload an actual firearm. For example, if a firearm replicated by simulated firearm 10 had a magazine sized to accept 15 rounds, then simulated firearm 10 would need to be reset after each 15 shots. In at least one preferred embodiment of the present invention, the process of reloading simulated firearm 10 is accomplished by removing and reinserting battery 20 after a predetermined number of shots. This action would simulate the actions associated with the insertion of a new magazine in a firearm to reload the firearm.

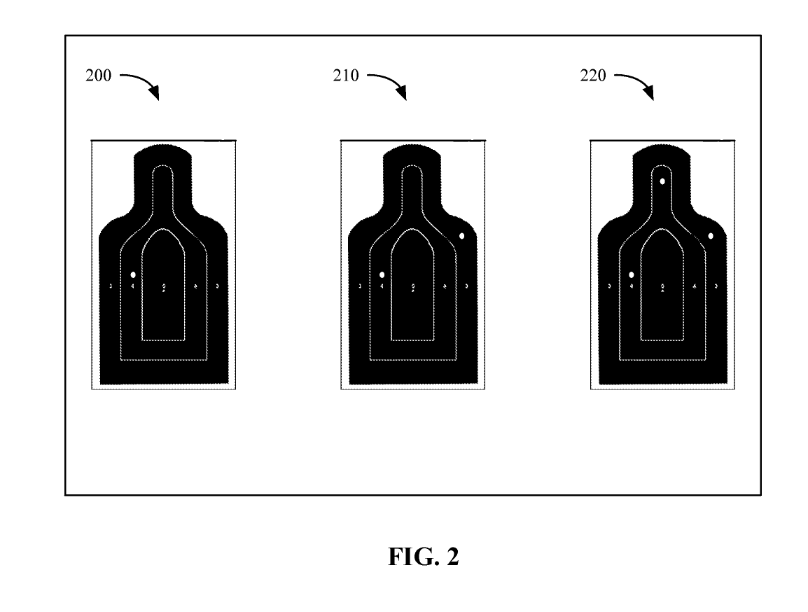

Referring now to FIG. 2, a series of digital images of photographs with “hits” that have been superimposed on the digital images of the photographs as captured by digital camera 18 of FIG. 1 is depicted. Moving from left to right, from target 200 to target 210 to target 220, the “hits” are captured by digital camera 18 for later review and analysis. As shown in FIG. 2, three different “hits” have been recorded. The digital images may be individual still photographic images or a series of images captured during a video sequence.

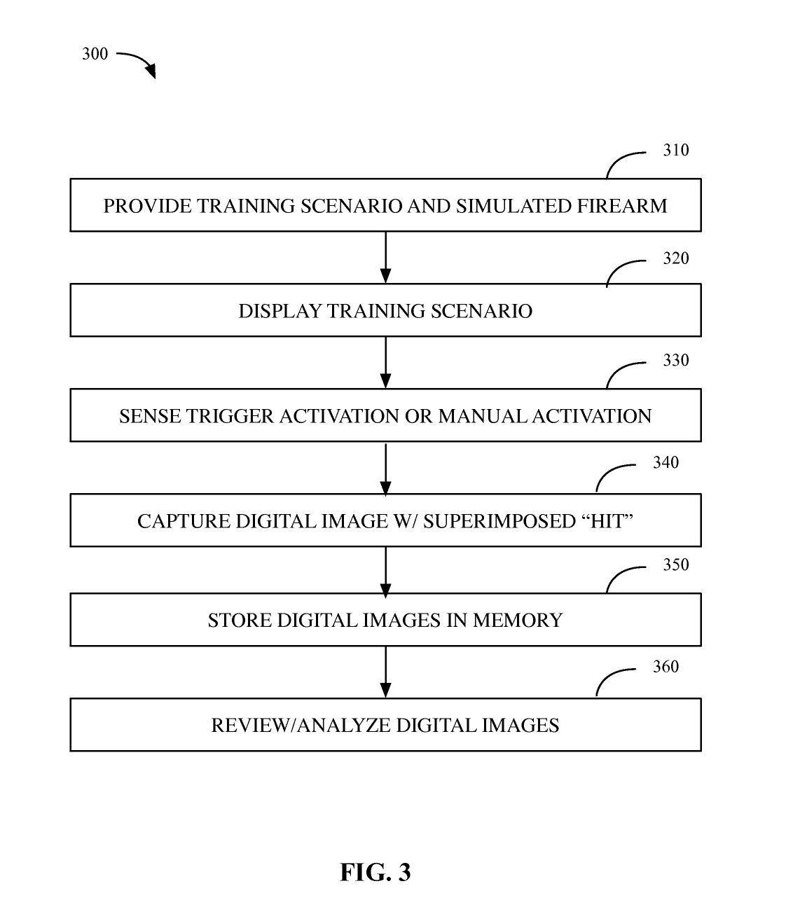

Referring now to FIG. 3, a flowchart for a training method 300 using a simulated firearm and associated target in accordance with a preferred exemplary embodiment of the present invention is depicted. As shown in FIG. 3, a training scenario and simulated firearm is provided (step 310) for training one or more trainees in a simulated training environment. The training scenario is displayed to the trainee (step 320) via any method known to those skilled in the art. For example, a live action training scenario with actors may be presented to the trainee. Similarly, a video screen with video sequences may be presented to the trainee.

The simulated firearm will monitor the trigger of the simulated firearm and sense the activation of the trigger by the trainee. Alternatively, manual activation by the trainee or the instructor will also be monitored and sensed (step 330). Once activated, the digital camera will capture the location of the “hit” and superimpose the image of the “hit” on the digital image (step 340) and the digital image will then be stored in memory (step 350). After the training exercise has been completed, the digital images can be reviewed and analyzed (step 360) to provide an enhanced training solution.

After being presented with the information presented here in, one of ordinary skill in the art will realize an embodiment of the present disclosure can be implemented in software, firmware, and/or a combination thereof. Program code according to the present disclosure may be implemented any viable programming language such as basic, C, C++, .Net, Fortran, JavaScript, Java, Pascal, PERL, HTML,XML, or SQL, or a combination of any of the foregoing or the equivalence there of or any other viable programming language, or a combination of high level programming languages and low-level programming languages such as machine code or assembly language, for example.

From the foregoing description, it should be appreciated that simulated firearm system disclosed herein presents significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims. For example, although the various preferred embodiments illustrated in the drawings are directed towards handguns, the embodiments of the invention is not limited to handguns. The principles disclosed herein contemplate the use of any firearm, including rifles and shotguns of all types to create a similar simulated firearm training system, using the methods disclosed herein.

Likewise, any methods disclosed here in represent only one possible sequence of performing the steps thereof. For example, those skilled in the art may determine a particular implementation with a plurality of steps of one or more of the method steps maybe combinable, or that a different sequence of steps maybe employed to accomplish the same or substantially similar results. Each such implementation falls within the scope of the present disclosure is disclosure and the claims set forth herein. Furthermore, the present disclosure is intended to cover such departures from the present disclosure as may be employed by those skilled in the art when implementing one or more embodiment of the invention to which this disclosure pertains.

1. A simulated firearm comprising:
a housing in the shape of a functioning firearm, the housing comprising a trigger; and
a camera mounted inside the housing, the camera being positioned in a location approximating a muzzle location of the functioning firearm, the camera being communicatively coupled to the trigger.

2. The simulated firearm of claim 1 further comprising a recoil simulation mechanism electronically interconnected to the trigger.

3. The simulated firearm of claim 1 further comprising:
a processor mounted inside the housing, the processor being electronically interconnected to the camera; and
a memory mounted inside the housing, the memory being electronically interconnected to the processor.

4. The simulated firearm of claim 1 further comprising a recoil simulation mechanism electronically interconnected to the trigger, the recoil simulation mechanism comprising a counterweight.

5. The simulated firearm of claim 1 further comprising a selectively removable battery mounted inside the housing, the battery being electronically interconnected to the trigger and the camera.

6. The simulated firearm of claim 1 further comprising:
a processor mounted inside the housing, the processor being electronically interconnected to the camera;
a memory mounted inside the housing, the memory being electronically interconnected to the processor; and
a headset, the headset being in a location external to the housing, the headset receiving a signal from the processor, the headset emitting a simulated gunshot report.

7. The simulated firearm of claim 4 wherein the recoil simulation mechanism comprises:
a coil;
a magnetic core contained within the coil; and
a counterweight, the counterweight being moved from a first position to a second position by a movement created by the coil and the magnetic core, thereby simulating a force associated with a recoil.

8. The simulated firearm of claim 1 further comprising:
a processor mounted inside the housing, the processor being electronically interconnected to the camera;
a reset switch, the reset switch being activated to simulate a magazine reload procedure;
a memory mounted inside the housing, the memory being electronically interconnected to the processor; a recoil simulation mechanism electronically interconnected to the trigger, the recoil simulation mechanism comprising:
a coil;
a magnetic core contained within the coil; and
a counterweight, the counterweight being moved from a first position to a second position by a movement created by the coil and the magnetic core, thereby simulating a force associated with a recoil; and
a headset, the headset being in a location external to the housing, the headset receiving a signal from the processor, the headset emitting a simulated gunshot report.

9. A method of simulated firearms training comprising the steps of:
providing a training scenario and a simulated firearm, the simulated firearm comprising:
a camera; and
a trigger;
displaying a training scenario to a trainee;
sensing activation of the trigger;
capturing at least one digital image based on the activation of the trigger; and
superimposing a simulated bullet impact on the at least one digital image.

10. The method of claim 9 further comprising the steps of:
reviewing the digital images; and
analyzing the digital images as part of a post-training exercise review.
